(19) United States
(12) Patent Application Publication
(10) Pub. No.: US 2026/0236560 A1
(43) Pub. Date: Aug. 13, 2026

(54) Dynamic Calculation

(71) Applicant: Ying Lun Chu, Whitestone, NY (US)

(72) Inventor: Ying Lun Chu, Whitestone, NY (US)

(21) Appl. No.: 18/935,236

(22) Filed: Feb. 13, 2025

(51) Int. Cl. G06F 17/18

(52) U.S. Cl. CPC G06F 17/18

(57) ABSTRACT

Dynamic Calculation is a universal framework for managing dynamic systems in both natural and computational environments. By applying principles of Contract, Attract, Diminish, Misbehave, and Offset, Dynamic Calculation enables real-time stabilization of complex data flows, bridging binary determinism with quantum probabilistic outputs. The theory's guiding principle is Equilibrium, representing the state of harmony and systemic stability across diverse applications.

### CROSS-REFERENCE TO RELATED APPLICATIONS

None

### STATEMENT REGARDING FEDERALLY SPONSORED RESEARCH OR DEVELOPMENT

None

### THE NAMES OF THE PARTIES TO A JOINT RESEARCH AGREEMENT

None

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

None

### STATEMENT REGARDING PRIOR DISCLOSURES BY THE INVENTOR OR A JOINT INVENTOR

No prior public disclosures of the invention have been made by the inventor.

### BACKGROUND OF THE INVENTION

Traditional mathematical models struggle to capture the continuous, ambiguous nature of energy observed in natural systems and computational environments. This limitation persists in hybrid systems, where deterministic binary data meets probabilistic quantum states. Dynamic Calculation bridges this gap, offering a universal framework designed to manage fluctuating states and energy flows across diverse fields, from economics to quantum computing.

### (1) Field of the Invention

Dynamic Calculation, a universal mathematical framework designed to understand, manage, and interpret the fundamental nature of dynamic systems across both natural and artificial environments. Its core principles—Contract, Attract, Diminish, Misbehave, and Offset—enable comprehensive analysis and stabilization of fluctuating energy flows within complex systems. This invention is a new paradigm for interpreting the universe itself, with applications in economics, quantum computing, artificial intelligence, energy systems, ecological networks, and the medical field. (2) Description of Related Art Including Information Disclosed Under 37 CFR 1.97 and 1.98

Traditional mathematical models rely on static assumptions and deterministic outcomes. While effective within defined parameters, these models often struggle to capture the dynamic, fluid nature of real-world systems, where change, uncertainty, and adaptability are constants. In contrast, Dynamic Calculation emerged from the systematic observation of natural phenomena and the recognition of dynamic pattern of the universe itself. By identifying core principles—Contract, Attract, Diminish, Misbehave, and Offset—this framework introduces a novel mathematical approach to understanding the universe. Dynamic Calculation represents a paradigm shift, providing a universal framework for interpreting both natural and artificial systems. It enables comprehensive analysis of fluctuating energy flows, offering solutions to challenges where traditional models fall short, including applications in economics, quantum computing, artificial intelligence, energy systems, ecological networks, medical field and beyond.

### BRIEF SUMMARY OF THE INVENTION

Dynamic Calculation is a comprehensive model for mathematically interpreting natural dynamics. It introduces five core principles-Contract, Attract, Diminish, Misbehave, and Offset-each representing a distinct aspect of energy and system behavior. Unlike traditional models that rely on static assumptions, Dynamic Calculation continuously adapts to ever-changing environments, driven by its central stabilizing force: Equilibrium.

### BRIEF DESCRIPTION OF THE SEVERAL VIEWS OF THE DRAWING(S)

No drawings are included in this application as the invention is a universal mathematical framework based on its conceptual principles and theoretical foundations

### DETAILED DESCRIPTION OF THE INVENTION

### 1. Core Principles

Contract: Manages energy flow by either concentrating resources inward or dispersing energy outward to maintain system efficiency.
Attract: The harmonious alignment of forces moving in the same direction, creating stability within the system.
Diminish: Represents natural loss or degradation, illustrating the progressive weakening of energy over time.
Misbehave: Represents the volatility and fluctuation of the mass of a number, emphasizing the inherent uncertainty and instability of numerical activity within dynamic environments. In such systems, the mass of a number is never stable, reflecting constant shifts and unpredictable variations. In short, Misbehave is unexpected, unstable, uncertain, chaotic movement as a phenomenon detected, which yields the foundational number “Unknown”.
Offset: Marks the vanishing point where detectable energy ceases, representing the system's return to complete equilibrium. It embodies the starting point of an ending point, where dual forces collide, releasing or gathering energy until they cancel each other out, leaving no detectable energy behind.

### 2. Foundational Numbers

0: The null or starting point, representing absence or minimal influence. 0 is not a static void but a dynamic state of potential where possibilities arise. As singularity collapses from the state of ‘1,’ it approaches ‘0 ,’ then slowly or rapidly expanding close to “1” in a recurring cycle.
1: Unity or singularity, representing wholeness and coherence within the system, yet inherently prone to rapid collapse. While it embodies the wholeness of the universe, this state of unity is fragile. When a system reaches ‘1,’ it quickly collapses into singularity-the collapse of energy. Collapse is the mechanism that prevents stagnation. Without collapse, Unity would freeze the system.
Infinite: the preservation of nearly all energy and matter, signifying the state of continuously moving toward ‘1’ without ever fully reaching it. Infinite is defined as movement, a dynamic progression, whereas singularity is a result-a terminal state where unity is achieved, but inherently unstable, leading to collapse.”
Unknown: Uncertainties or variables that may fluctuate, adding adaptability to the model. The role of Unknown can be described metaphorically as the dynamic movement of energy within a ball-like state. Each instance of Unknown is unique because the energy inside this state interconnects and fluctuates chaotically, resembling characteristics of quantum behavior. Unknown is not to be confused with Flow, as it represents chaotic fluctuations, whereas Flow follows Attract as part of the system's progression.
Equilibrium: The purpose of Dynamic Calculation is to pursue equilibrium—a state of dynamic harmony where forces continuously adjust to maintain balance. Any deviation, or ‘dissonance,’ represents movement away from this state, signaling the system's need to adapt. Equilibrium serves as the guiding principle, applying across all scales, from simple interactions to the most complex systems.

### 3. Illustrative Examples

Economics: Balancing inflation through dynamic resource management to ensure sustainable economic growth.
Energy Systems: Stabilizing renewable and non-renewable resource flows to optimize energy efficiency and reduce environmental impact.
Ecology: Maintaining biodiversity through adaptive conservation strategies.
Hybrid Computing Systems (Dynamic Calculation Converter—DCC): Dynamic Calculation optimizes data stabilization and error correction in hybrid systems integrating binary and quantum processes. In the Dynamic Calculation Converter (DCC), principles such as Contract and Misbehave manage fluctuating quantum states while ensuring data stability through deterministic binary outputs. This enables real-time data processing with both computational efficiency and systemic equilibrium.

### 4. Technical Implementation

Dynamic Calculation operates through an integrated processing system comprising three key stages:
Data Ingestion: Captures raw input from either binary or quantum sources. Quantum inputs include probabilistic states, while binary inputs involve deterministic values.
Dynamic Processing: Applies the principles of Contract to consolidate data, Diminish to filter noise, Misbehave to identify fluctuations, Attract to align stable patterns, and Offset to achieve equilibrium.
Adaptive Feedback Loop: If systemic equilibrium is not achieved after initial processing, data is re-evaluated through Misbehave and Contract to ensure stability, creating a self-correcting feedback loop within hybrid systems.
Equilibrium in Computing: In computational systems, Equilibrium represents a state where data variance is minimized, achieving maximum stability across hybrid environments.
Example: Dynamic Calculation operates seamlessly in hybrid computing environments through the Dynamic Calculation Converter (DCC), which translates quantum probabilistic outputs into deterministic binary data, enabling effective application of Contract, Attract, Diminish, Misbehave, and Offset.

1. A method for managing dynamic systems by applying the principles of Contract, Attract, Diminish, Misbehave, and Offset to achieve equilibrium within complex environments.

2. The application of Dynamic Calculation to economic models to stabilize inflation, minimize surplus, and enhance resource efficiency.

3. A system or method for applying Dynamic Calculation principles to optimize real-time data processing in complex, adaptive environments.

4. A system for processing quantum outputs using Dynamic Calculation principles, applying deterministic binary correction mechanisms to achieve data equilibrium.

5. A method for processing hybrid binary-quantum data with the Dynamic Calculation Converter (DCC), comprising:
Receiving quantum data with probabilistic fluctuations and binary data with deterministic values;
Detecting and managing anomalies in quantum data using Misbehave, identifying chaotic patterns;
Stabilizing quantum fluctuations into discrete, manageable values using Contract, focusing unstable data into coherent structures;
Aligning stabilized data towards deterministic states using Attract, fostering coherence between quantum and binary layers;
Filtering noise and reducing computational instability through Diminish, ensuring only relevant data persists;
Validating the processed data through the binary correction layer;
Producing stabilized, deterministic outputs through Offset, achieving systemic equilibrium; and
Adaptive Feedback Loop: In response to detecting that equilibrium is not achieved, the system dynamically reprocesses data by reapplying Misbehave and Contract until stabilization is verified.
